(19) United States
(12) Patent Application Publication
(10) Pub. No.: US 2002/0105589 A1
(43) Pub. Date: Aug. 8, 2002

(54) System and method for lens filter emulation in digital photography

(76) Inventors: Sarah M. Brandenberger, Boise, ID (US); Douglas G. Keithley, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/776,058

(22) Filed: Feb. 2, 2001

(51) Int. Cl. H04N 3/14; H04N 5/335

(52) U.S. Cl. 348/360; 348/273; 348/239

(57) ABSTRACT

The present invention is directed to a system and a methodology for including software controlled filtering effects in digital cameras to reduce the need for physical filters. Filtering effects emulated by the software include technical filters, correction filters and effects filters. The invention includes an input system which allows the user to select various filtering effects, preview the filtered image and record the filtered image in a lossy compressed file format. The input system may consist of a hierarchical menu system, touch screens, voice activation, pointing devices or a round robin mechanism. In addition, the input system includes an ability for the user to indicate a selection has been made such as an enter key or a selection completion signal.

### TECHNICAL FIELD

This invention relates to digital photography, and more specifically, to the introduction of filtering effects through the use of software in digital cameras.

### BACKGROUND

The use of filters in conventional photography utilizing photographic film is well known in the prior art. Typically, camera lenses include threads on the inner portion of the lens barrel which allow optical filters to be threaded onto the lens assembly in front of and in optical alignment with the front lens element. To a limited degree, filters can be combined by attaching more than one filter to a lens. Optical filters may be used to introduce various effects into photography, or, to overcome problems that have been created by the interaction of different light sources with modern film, i.e., “stacking filters.” These optical filters are typically classified as effects filters and as technical filters respectively. Effects filters can further be categorized as either filters which magnify or highlight a specific characteristic of the image, or those filters which introduce a new element into the image. Filters which enhance characteristics of the image include sky filters, autumn filters, colored filters, tint filters, and similar color enhancing and modifying filters. This type of filter enhances, or brings out, colors within the image by introducing a colored tint to the filter. This coloring can be used to make the sky look bluer, pictures of foliage more brilliant, or sunsets more dramatic. Some filters may be optically “colorless” or “neutral” to attenuate invisible wavelengths (e.g., U.V. filters), all visible wavelengths (e.g., neutral density filters), or to reduce contrast (e.g., milky white contrast filters).

The second set of effects filters introduce components or characteristics in the photograph which weren't present in the original image. An example of this type of effects filter is a star filter. A star filter will make a point of light in the image appear as a star on the photograph. Selective star filters are also available which will only modify the points of light in a selected portion of the image. Filters can also be used to introduce degrees of diffusion in the photograph which simulate a soft focus. Perhaps the best known effects filter is a polarizing filter which may be used to eliminate reflected light and glare from photographs.

As previously stated, technical filters overcome problems created by the interaction of different light sources and modern film. These filters are sometimes called correction filters. One type of technical filter makes corrections to the color temperature of the light entering the camera. These filters create a balance between the light source's color temperature and the color temperature for which the film is balanced. Other types of technical filters are used to create special effects or absorb various degrees of color in black and white photography.

Optical filters can be used in digital photography in much the same way as they have been used in film photography. The use of threaded optical filters in digital photography creates a number of difficulties. First, to effectively and consistently use optical filtering of an image, a number of optical filters must be carried to the location at which the photography will occur or the photographer must be familiar enough with the location to predict the specific filters required. Second, even if a photographer understands filtering effects well, effective use of filters requires some trial and error or bracketing. Bracketing is when a photographer takes a number of pictures with varying parameters such as varying exposures. By bracketing a picture, a photographer increases his/her chances of capturing a properly exposed and useable image.

Some filtering effects can also be introduced in digital photography by loading a digitized image from a digital camera, scanner, or other imaging device onto a computer so that the resultant image can be processed and manipulated. These image processing software packages typically include a menu which provide selection of various filtering effects. The effects of these filters can be introduced into the digital image contained in the computer and are typically previewed before being finalized. For instance, a warming filter may enhance “warm” tones, such as shades of yellow, brown or red, in a digital image to make the image appear warmer. Similarly, sharpening, making the boundaries between objects in the images appear cleaner, or blurring, introducing noise into boundaries between objects in the images to appear “less clean” can be accomplished via software.

Video cameras have also, for some time, included manual and automatic color or white balancing which allows the videographer to compensate for color temperatures of the illuminating light. For example, incandescent indoor lighting is a warm color and includes a large amount of yellow light. Balancing can be used to reduce or balance out the excess yellow present. However, such color temperature adjustment mechanisms are typically limited to controlling the gain of the color components to compensate for a single peak in the color temperature of the illuminating light.

While optical filters provide some flexibility, digital image manipulation and enhancement is typically performed only “off-line” after the image has been captured and downloaded to a suitable computer system. This means that a photographer must wait until after a photo shoot to see the results of computer based digital image processing. Thus, the photographer may not know what, if any, changes to the initial, on-site image capture (i.e., exposure, composition, resolution, etc.) may further support or enhance a final desired image when subjected to only later available image manipulation. Additionally, while a number of filters can be attached to a lens, “barreling” and light loss limits the practical number of filters which can be combined. Barreling occurs when the sides of the lens or filters interfere with the captured image.

A need exists for an apparatus and method that will allow a photographer using digital or image capture equipment the ability to preview filtering effects without the need of replacing each individual filter on their digital camera. A further need exists to allow these previews without requiring the photographer to carry physical filter elements. A further need exists which will allow digital photographers to combine filters without the limitations of barreling.

### SUMMARY OF THE INVENTION

The present invention is directed to a system and method for software emulation of filters in digital cameras. In one embodiment the invention includes a digital camera comprising an optical lens system which provides an optical image to an image sensor, where the image sensor provides unprocessed digital image data. The digital camera includes an input device which responds to a manual input from the user for selecting one of a number of image filters and a processor configured to adjust the image digital data to emulate the selected image filter effects and provide filtered image data. The filter image can also be stored. The stored image may use lossy compression of the filtered image data to provide compressed image data, and the compressed image data may be stored in this format. The digital camera can include a display which allows the user to view the filtered image. The image sensor can be a color charged coupled device array. The input device can be a touch sensitive overlay provided on the display and may consist of menued options. The input device can also respond to the user's voice. The digital camera may further support combinations of filtering effects.

Another embodiment of the invention includes an apparatus for recording filter images comprising a menu for selection of a filter effect on a digital visual recording device where the menu permits selection of a filter, adjustment of the filter properties, and allows an electronic representation (a preview) of the filtered image. The menu may be hierarchical in nature. The electronic representation may be captured on a removable media. The filter effects include one of effects filters, technical filters and correction filters and may include variations in color intensity. The apparatus also supports cancellation of the filter effect.

Another embodiment of the invention includes a method of combining filter effects into digital photography where the method comprising the steps of selecting a first filter and second filter on a digital recording device and combining the first filter and the second filter effects to create a combined filtering effect. The properties of the digital recording device can be adjusted to include combined filtering effects and to record the filtered image on an electronic media. A hierarchical menu system may be used. The filter image may be previewed and stored on removable electronic media. The filtering effects may include effects filters, technical filters, and correction filter effects and may include variations in color intensity.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a block diagram of an apparatus of a digital filtering device;

FIG. 2 shows a hierarchical menu structure for filtering selection; and

FIG. 3 shows a hierarchical menu structure for selecting filtering amounts, shapes and positions.

### DETAILED DESCRIPTION

The invention incorporates robust digital image manipulation capabilities into the platform used to capture the digital image, e.g., a digital camera. According to one embodiment of the invention, a low resolution preview image may be processed by the image manipulation software to allow the user to observe various filter effects, select an appropriate effect and, as necessary, make adjustments to the image capture process to account for filtering. The image manipulation may be performed as a part of the final, high resolution image capture (e.g., as modified pixel data); after capture but prior to any further image processing steps; after some image processing but prior to any lossy image data compression (e.g., JPEG encoding); immediately prior to storage (e.g., transfer of compressed image data to a compact flash card) or after storage and retrieval of the stored image data. For example, color balancing may be performed by oversampling a color, or colors, to be enhanced; while undersampling a color, or colors, to be suppressed. Similarly, other effects may be implemented during or as part of the image data capture from the imaging device (e.g. CCD) such as “speed” effects wherein successive scan lines are progressively shifted to suggest a direction of travel of an object. Other processing, particularly those image manipulations requiring reference to adjacent lines of pixels, may be performed on the captured red, green and blue bit-mapped image prior to other processing that might conflict with the desired effect and prior to compression of the image data.

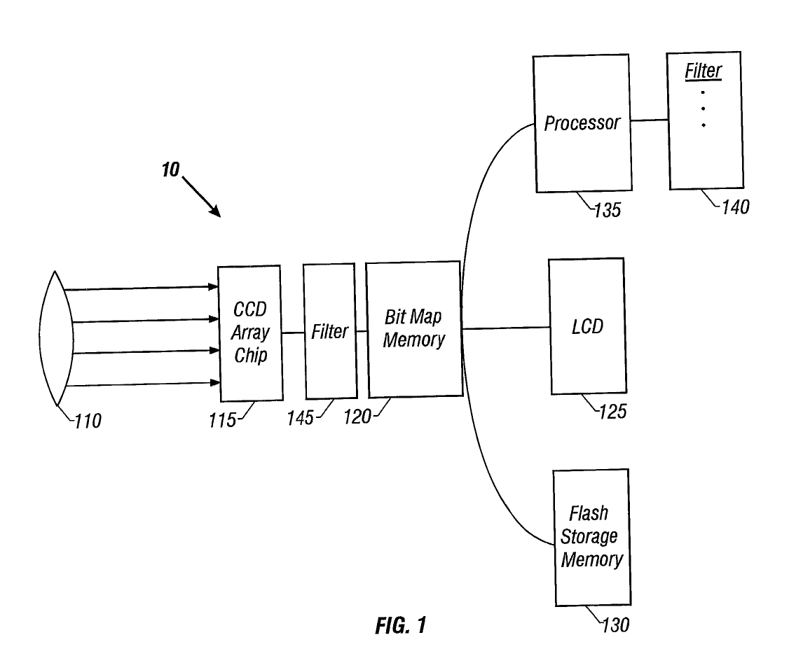

FIG. 1 is a diagram of a digital camera 10 which includes integrated digital image filtering capabilities. Light from the photographed scene enters lens 110 and is registered on Charge Coupled Device (CCD) array chip 115. Conceptually, the chip is composed of two dimensional arrays of photodetectors (e.g. photodiodes) where groupings of three nearby photodetector elements (one per primary color) account for each picture element (i.e., pixel) of the image. That is, each point of the photographed image is captured on three pixels, a green sensitive pixel, a blue sensitive pixel and a red sensitive pixel. Pixel data from the CCD array is translated and stored in bit map memory 120 which stores the digitized image as digitized red, green and blue intensity values, each color typically representing an intensity value from 0 to 255 using binary bits (i.e., one byte per color). Bit mapped memory 120 could be 14 bit/pixel so that microprocessor 135 would have full resolution data to run a filter on. This digital information is displayed to the photographer through, for example, a color Liquid Crystal Display (LCD) 125. When the photographer decides to store a digital image, the bit mapped image may be compressed using, for example, a lossy compression technique, and the compressed image data can then be stored in memory, such as flash storage memory 130. The photographer can also apply filtering effects through processor 135 and filtering menu selection 140. In response to the filtering menu selections selected by the photographer, processor 135 adjusts the red, green and blue intensity values in accordance with the selected filtering. A multi-line first in/first out (fifo) and filter 145 may optionally be included to allow the filter to be implemented on full resolution data prior to being stored in memory. The addition of the fifo and filter may also require less system memory due to subsampling or compressing (if desired) prior to storing in memory. This may increase the overall speed of the digital camera.

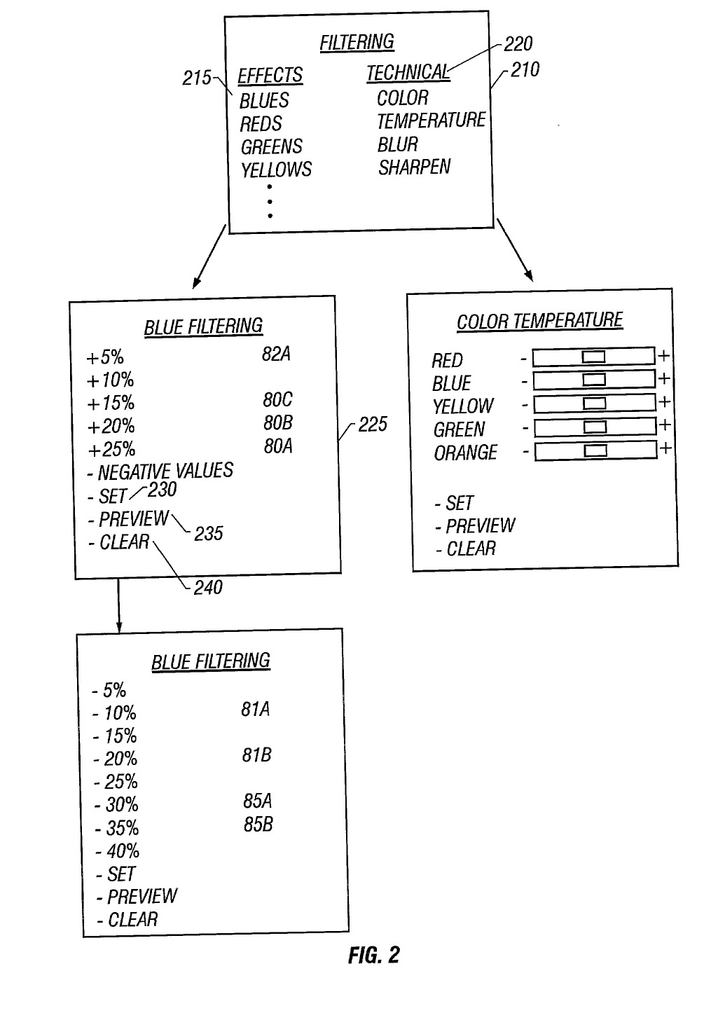

In FIG. 2, a menu system is illustrated in which the digital photographer may select the type of filtering desired. Main filter menu 210 allows the photographer to select the class of filtering desired, such as Effects Filters 215 or Technical Filters 220. If Effects Filters 215 is desired, the photographer selects one of the color choices displayed in that category. Selection may be accomplished by a touch screen, voice, a pointing device (such as a trackball) or a cyclic or round robin mechanism or the like. In each of these methods of selection a means must be available for the photographer to indicate the completion of his/her selection. This may be accomplished through an enter key or other signal.

Once the photographer's selection of the class and color of filtering desired is accepted by the digital camera, the camera updates the screen to display the next menu. Referring again to FIG. 2, if the photographer selected a blue effects filter, an adjustment screen is displayed to the photographer in which the photographer may select the percentage of blue filtering desired, either positive 225 (i.e., enhance blues), or negative 227, (i.e., suppress blues). The photographer may again indicate his/her selection through a touch screen, voice, pointing device or round robin device or the like. Once the amount of filtering is indicated by the photographer, the photographer must choose between selecting the filter effect for the next picture or previewing a real time image being captured through the selected filtering. These selections are made by selecting the set 230 button or preview 235 button respectively. Alternatively, the photographer may clear previously set filtering by selection of the clear 240 choice.

Similarly, if the photographer desires to use technical filtering 220, the photographer may select the type of technical filtering desired. Once the type of filtering desired is selected, the digital camera may display additional screens to prompt the photographer to enter additional information. As shown in FIG. 2, various colors for color temperature compensation may be displayed to the photographer as choices.

Color images on most digital camera displays are composed of the three primary additive colors, red, green and blue. Filtering of these primary colors is typically accomplished by adjusting the amount of red, green or blue with respect to other two colors. For example, if a photographer, using a conventional film camera, desires to decrease the orange coloring of the sun in a sunset photograph, he/she could place a blue optical filter on their camera lens which will allow more blue light to be transmitted to the film to offset the loss of blues caused by atmospheric filtering of the sunlight. Similarly, in digital photography, the digital photographer could attach a blue optical filter to the lens system of his/her camera to obtain a similar effect.

Alternatively, as disclosed herein, this filtering can be accomplished via imaging processing software resident and executed in a digital camera. Referring again to FIG. 2, the digital photographer may select implementation of a blue color filter from Effects 215 portion of filtering screen 220. Additionally, the photographer would select the amount of blue filtering required. Blue filtering can be accomplished by enhancing “blues” as indicated by a positive value and corresponding to “cooling” photographic filter types 82A, 80C, 80B, and 80A (in order of decreasing color temperature) or by reducing blue tones as indicated by negative values and corresponding to warming photographic filters 81A, 81B, 85A and 85B. In response the software within the digital camera would increase the intensity of the pixels dedicated to blue or alternatively, decrease equally the intensity of the pixels associated with red and green pixels. Conversely, instead of decreasing the blue, red and green values may be increased.

The invention further provides digital equivalents of partial or cross-screen optical filters. For example, in film photography, filtering can be applied to a portion of the photograph. For instance, a blue filter can be applied only to the upper portion of the picture including the sky, with an optically clear filter or no lens, applied to the balance of the photograph. Digital filtering can duplicate this type of filtering and can increase the filtering capabilities. For example, digital filtering can accommodate complex filtering geometries, multiple gradients, and other variations not possible or practical with optical filters.

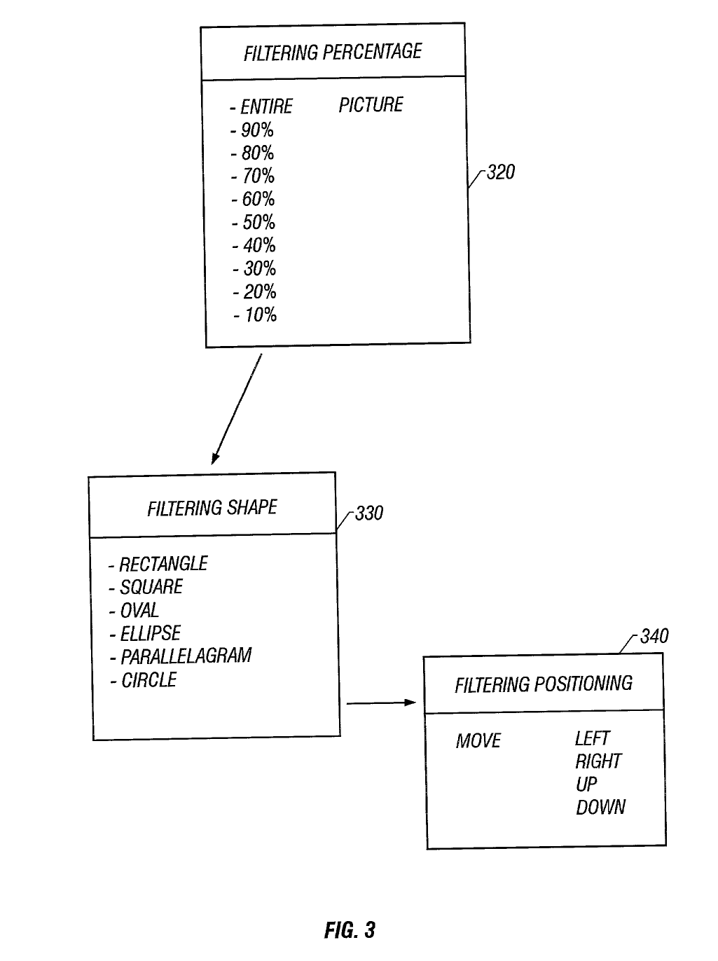

Referring to FIG. 3, once filtering is indicated as described with respect to FIG. 2, the digital camera can prompt the user to designate a portion of the picture to apply filtering to, the shape of the filtering applied, and the position of the filtering applied. Using filtering percentage menu 320 the system prompts the user to indicate how much of the viewed image the photographer would like to apply filtering to. The photographer can select the amount of filtering (i.e., filter density) via touch screen, voice, a pointing device, arrows or a round robin entry device, or the like.

In response to user selection of filter type and density (percentage), the digital software would then display filtering shape screen 330 to the user and the user would use the screen to select which shape of filtering is desired. Once the shape is selected, the user, through Filtering Positioning screen 340, may select the position within the pictured image the filtering should be applied. Once the filtering parameters, percentage, shape and positioning are selected, the user positions the image to be photographed within the display window or LCD accordingly. Alternatively, the user may be allowed to define filter areas using a free form input device to outline a portion of the picture, move, resize and reshape the area, and otherwise designate portions to be filtered.

Similarly, other filtering effects can be implemented in software, and, unlike conventional film photography in which only a limited number of filters may be “stacked”, these digital filtering techniques can be combined as desired. This is because digital cameras typically store pixel brightness information indicative of each of the primary additive colors, red, green and blue. If the red, green and blue components are properly balanced, the corresponding portion of the captured image will appear white. Additionally, as the separate color intensities increase in proportion to one another, the white light will appear brighter.

Digital filtering can operate on this information to introduce new filtering affects. For instance, the digital photographer may select a star filtering to selectively affect all white colored light sources (i.e., relatively bright, small objects) and generating corresponding colored (i.e., white) radiating lines outward from such light sources. Similarly and simultaneously, a halo affect may be generated in connection with bright red objects, e.g., those having a red luminesce value of at least 200 out of a maximum of 255.

Applying filtering effects to images before they are recorded also helps capture the recorded filtered image more clearly prior to loss of data resulting from lossy compression including data quantization, reducing the color plane bit depth. In current digital photography, storage space is conserved by compressing the image resulting in a loss of image detail and color information. When filtering or other image manipulation is performed after lossy compression, as when printing software is used to add filtering, the filtering effects are applied to the quantized, stored data rather than the original image data. By applying the filtering to the image before it is saved, more uniformed filtering is obtained.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. The menus included in this description are not meant to limit this invention to the format of the menu or to the use of menus themselves. The menuing system is but one method in which the user's preferences are received by the digital camera. A simple scroll feature may also be used to allow the user to indicate their selection. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. While the selection of filters herein have been described in terms of percentages, filters may also be presented and selected by their photographic nomenclature.

What is claimed is:

1. A digital camera comprising:
an optical lens system providing an optical image,
an image sensor providing pixel data corresponding to said optical image;
an input device configured to respond to a manual input selecting one of a plurality of image filters; and
a processor configured to process said pixel data in response to said selected image filter to provide filtered image data.

2. The digital camera of claim 1 further comprising:
a display configured to provide a visual display of said filtered image data; and
where the input device is a touch sensitive overlay provided on said display.

3. The digital camera of claim 1 further comprising:
an image storage configured to implement lossy compression of said filtered image data to provide compressed image data, and store said compressed image data.

4. The digital camera of claim 1 wherein the image sensor is a color Charged Coupled Device array (CCD).

5. The digital camera of claim 1 wherein the input device includes menued options.

6. The digital camera of claim 1 wherein the input device include a voice processor configured to respond to voice commands.

7. The digital camera of claim 1 wherein a subset of said plurality of image filters are selectable by said input device and said processor is configured to provide a composite filter effect in response to selected ones of said subset.

8. An apparatus for recording digital images comprising:
a menu displaying a selection of a filter effect available on a digital visual recording device;
a processor configured to perform an adjustment of the properties of said digital visual recording device to include selected ones of said filter effects; and
an output providing an electronic representation of said filtered image.

9. The apparatus of claim 8 wherein said menu is configured to provide a hierarchical display of said filter effects.

10. The apparatus of claim 8 wherein said processor is configured to provide a preview of a filtered image.

11. The apparatus of claim 8 wherein said output includes a removable data storage media capturing said electronic representation.

12. The apparatus of claim 8 wherein said filter effects include one of effects filters, technical filters and correction filters.

13. The apparatus of claim 8 wherein said filter effects include variations in color intensity.

14. The apparatus of claim 9 wherein said processor selectively inhibits said filter effect in response to said input.

15. A method of combining filter effects into digital photography, said method comprising the steps of:
selecting a first filter on a digital recording device;
selecting a second filter on a digital recording device;
combining said first filter and said second filter to create a combined filtering effect;
adjusting properties of said digital recording device to include combined filtering effects; and
recording an image on an electronic media of said digital visual recording device which includes said combined filtering effects.

16. The method of claim 15 wherein said step of selecting is accomplished through a hierarchical menu, available before said image recording slip.

17. The method of claim 15 wherein said step of adjusting properties of said digital recording device includes providing a preview of said image which includes the filter effects.

18. The method of claim 15 wherein said step of recording includes recording onto a removable electronic data storage media.

19. The method of claim 15 wherein said filter effects include one of effects filters, technical filters, and correction filter.

20. The method of claim 15 wherein said effect filters include variations in color intensity.
